(19) United States
(12) Patent Application Publication
(10) Pub. No.: US 2003/0197388 A1
(43) Pub. Date: Oct. 23, 2003

(54) Robot arm having wafer-scratching prevention function

(75) Inventors: Shih-Chang Shih, Tainan (TW); Jaw-Lih Shih, Hsinchu (TW)

Correspondence Address: LOWE HAUPTMAN GOPSTEIN GILMAN & BERNER, LLP, 1700 Diagonal Road, Suite 310, Alexandria, VA, 22314, US

(73) Assignee: Taiwan Semiconductor Manufacturing Co., Ltd.

(21) Appl. No.: 10/378,104

(22) Filed: Feb. 27, 2003

(30) Foreign Application Priority Data
Apr. 22, 2002 (TW) 91108275

(51) Int. Cl. B25J 9/12

(52) U.S. Cl. 294/1.1; 294/902; 414/941

(57) ABSTRACT

A robot arm having wafer-scratching prevention function is disclosed. A touch control method is used in the robot arm to detect the abnormal situation of scratching a wafer, thereby promptly stopping the motion of robot arm from continuously accessing the wafer, so as to prevent a large amount of wafers from scrapping. The robot arm having wafer-scratching prevention function has an electrically conductive layer and an electrically non-conductive layer, wherein the non-conductive layer is located on one surface of the robot arm contacting a target wafer to be accessed, and the conductive layer is on the other surface opposite to the non-conductive layer. The conductive layer is connected to a circuit to generate a stopping signal for stopping the robot arm from continuously accessing the wafer.

### FIELD OF THE INVENTION

The present invention relates to a robot arm having wafer-scratching prevention function, and more particularly, to a robot arm of which the motion can be immediately stopped by using a touch control method.

### BACKGROUND OF THE INVENTION

In the semiconductor manufacturing process, a robotic arm is quite an important element in a wafer transporting apparatus, and whether the relative position between the robot arm and a wafer is aligned correctly concerns the overall production efficiency and yield.

Generally, a robot arm is used to access a wafer located in a wafer cassette, and then to carry the wafer to an apparatus for processing. Because the distance between the robot arm and the wafer located above, and that between the robot arm and the wafer located below, both are merely about 1.5 mm, any slight deviation of the position of the robot arm or the wafer, or slight deformation of the wafer cassette, results in the abnormal situation of the wafer scratched by the robot arm. Currently, the scheme for detecting wafer scratch is to install wafer detection devices among several processes. For example, a detecting device made by KLA-Tencor U.S.A. is to compare the differences of the circuit images on the respective wafers to detect if the wafers are scratched. However, each of the wafer cassettes contains for example 24 wafers, and due to the consideration of cost and production rate and the difficulties of actual production, the wafer detection devices cannot be widely and completely installed to detect every abnormal situation of scratches immediately caused by a robot arm. Thus, when a wafer scratch is detected, quite a few wafers have actually been accessed by the same robot arm, and it is very likely that wafer scrap has already happened.

Hence, there is a need for developing a robot arm having wafer-scratching prevention function, to detect the abnormal situation of scratched wafer at the first moment, and to promptly send out a signal immediately stopping the robot arm from continuously motioning, thereby avoiding wafer scrap, thus promoting the wafer yield.

### SUMMARY OF THE INVENTION

In view of the invention background described above, due to lacking of sound and complete wafer detection schemes, the error of a wafer scratched by a robot arm cannot be detected in time, so that wafer scrap is very likely to occur, causing huge production loss.

Hence, it is an object of the present invention to provide a robot arm having wafer-scratching prevention function for promptly detecting the abnormal situation of a wafer scratched by a robot arm, thereby stopping the motion of the robot arm promptly, so that the production loss can be limited to one single wafer and does not involve any other wafers.

It is another object of the present invention to provide a robot arm having wafer-scratching prevention function, wherein a conventional robot arm can be equipped with the wafer-scratching prevention function after being briefly modified.

In accordance with the aforementioned objects of the present invention, the present invention provides a robot arm having wafer-scratching prevention function, the robot arm comprising: a non-conductive layer, located on one surface of the robot arm, wherein the one surface is used for contacting a target wafer; a conductive layer, located on the other surface of the robot arm, wherein the one surface and the other surface are located on both sides of the robot arm; and a circuit, wherein the conductive layer is connected to the circuit with at least one conductive wire, so that when the conductive layer contacts a non-target wafer, at least one charge is generated and passed to the circuit.

In accordance with the aforementioned objects of the present invention, the aforementioned circuit can further be a touch switch circuit, and the conductive layer is connected to the touch switch circuit with at least one conductive wire, so that when the conductive layer contacts a non-target wafer, at least one charge is generated and passed to the touch switch circuit, and a stop signal is generated to stop the motion of the robot arm, after the touch switch circuit receives the at least one charge.

In accordance with the aforementioned objects of the present invention, the present invention provides a robot arm having wafer-scratching prevention function, the robot arm comprising: a conductive layer, located on one surface of the robot arm, wherein the robot arm is made of an electrically non-conductive material; and a circuit, wherein the conductive layer is connected to the circuit with at least one conductive wire, so that when the conductive layer contacts a non-target wafer, at least one charge is generated and passed to the circuit.

In accordance with the aforementioned objects of the present invention, the present invention provides a robot arm having wafer-scratching prevention function, the robot arm comprising: a non-conductive layer, located on one surface of the robot arm, wherein the one surface is used for contacting a target wafer, and the robot arm is made of an electrically conductive material; and a circuit, wherein the robot arm is connected to the circuit with at least one conductive wire, so that when the other surface of the robot arm contacts a non-target wafer, at least one charge is generated and passed to the circuit.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram showing a robot arm accessing a wafer correctly;

FIG. 2 is a schematic diagram showing a robot arm accessing a wafer incorrectly; and

FIG. 3 is a schematic diagram showing the structure of a robot arm according to a preferred embodiment of the present invention.

### DETAILED DESCRIPTION OF THE PREFERRED EMBODIMENT

The present invention discloses a robot arm having wafer-scratching prevention function. The present invention uses the touch control method to promptly detect the abnormal situation of a wafer scratched by a robot arm, so as to promptly stop the robot arm from continuously accessing the wafer, thus preventing wafer scrap.

Currently, the touch control method has been quite commonly applied on household appliances for enhancing the convenience and safety of turning on/off the appliances, such as touch-controlled lamps. When a user first touches a touch-controlled lamp, the lamp is turned on immediately; and, when the user touches the lamp once again, the lamp is turned off promptly. The touch control method is to design an electrical circuit by using the phenomenon that charges are generated while two conductors are in proximity to each other, wherein the phenomenon is the so-called stray capacity effect. The present invention utilizes the aforementioned touch-control method to design a robot arm, wherein charges are generated and passed to a touch control circuit, when the robot arm contacts the wafer which is not desired to be accessed; and then the touch control circuit generates a signal to stop the motion of the robot arm.

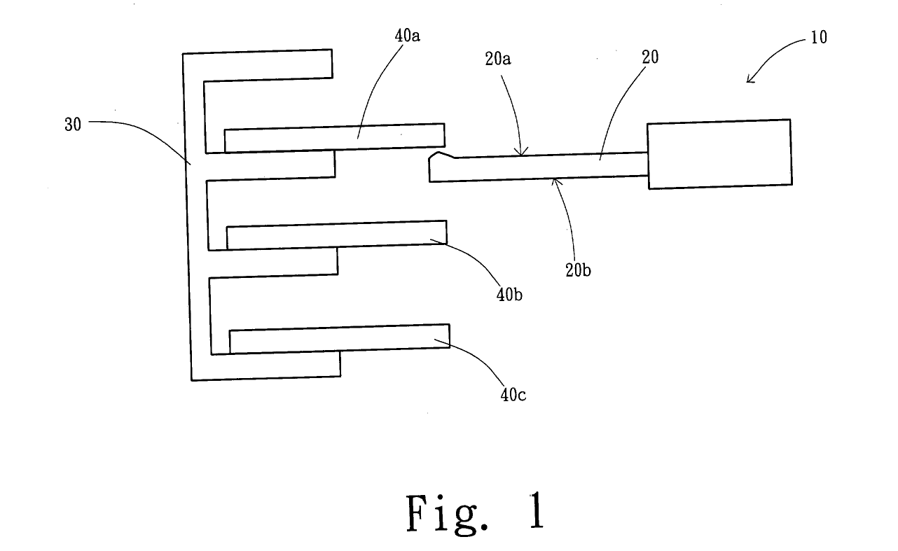

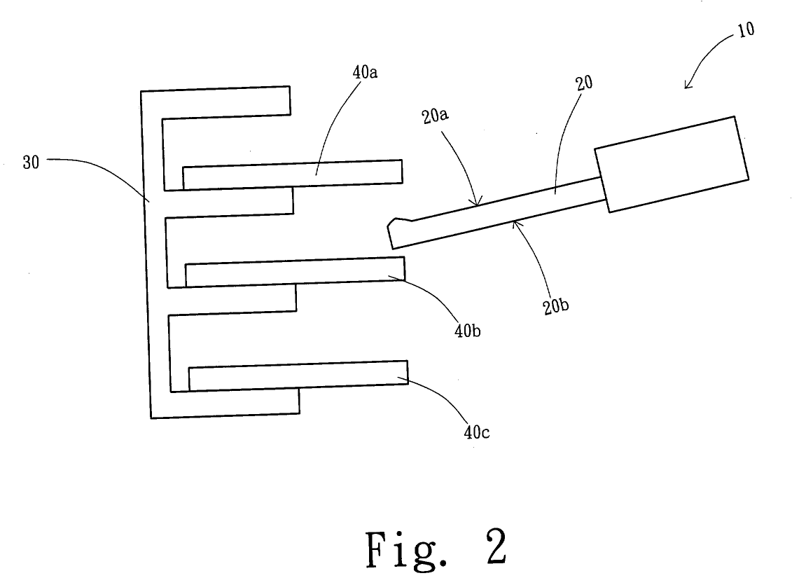

Referring to FIG. 1, FIG. 1 is a schematic diagram showing a robot arm accessing a wafer correctly, wherein a plurality of wafers 40a, 40b and 40c are placed in parallel to one another in a wafer cassette 30. While accessing the wafer 40a (i.e. a target wafer), if a robot arm 20 of a wafer transporting apparatus 10 is positioned correctly, only the surface 20a of the robot arm 20 will contact the wafer 40a desired to be accessed, and the surface 20b of the robot arm 20 will not contact the wafer 40b (i.e. a non-target wafer) located below and adjacent to the wafer 40a. Referring to FIG. 2, FIG. 2 is a schematic diagram showing a robot arm accessing a wafer incorrectly. While accessing the wafer 40a, if a robot arm 20 of the wafer transporting apparatus 10 is positioned incorrectly, such as that the robot arm 20 is tilted; the wafer cassette 30 is deformed; and the wafer 40b is placed tiltedly, etc., all will result in the scratch of the wafer 40b due to the surface 20b of the robot arm 20 contacting the surface of the wafer 40b.

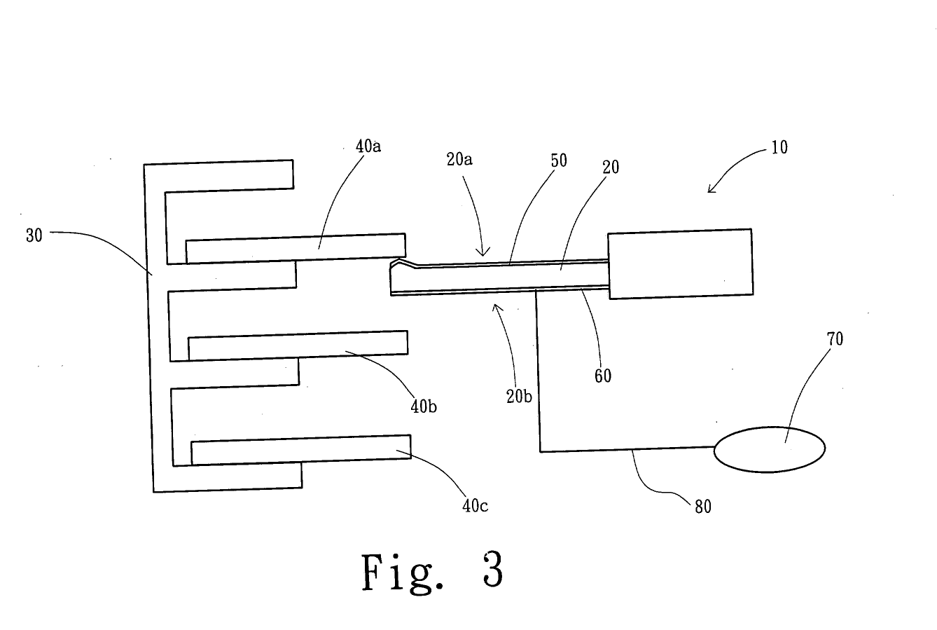

Referring to FIG. 3, FIG. 3 is a schematic diagram showing the structure of a robot arm according to a preferred embodiment of the present invention, wherein the surface 20a of the robot arm 20 has a non-conductive layer 50, and the surface 20b of the robot arm 20 has a conductive layer 60. The non-conductive layer 50 can cover the surface 20a entirely, or an appropriate portion of the surface 20a, as long as no charge is generated while the surface 20a contacts the wafer 40a. The conductive layer 60 can cover the surface 20b entirely, or an appropriate portion of the surface 20b, as long as a charge is generated while the surface 20b contacts the wafer 40b. If the robot arm 20 of the present invention is made of an electrically non-conductive material, such as ceramic material, then the surface 20a is made of the non-conductive layer 50 naturally, so that no non-conductive material layer has to be formed additionally, and thus, only an electrically conductive material layer needs to be formed on the surface 20b as the conductive layer 60; if the robot arm 20 of the present invention is made of an electrically conductive material, such as metal material, the surface 20b is made of the conductive layer 60 naturally, so that no conductive material layer has to be formed additionally, and thus, only an electrically non-conductive material layer needs to be formed on the surface 20a as the non-conductive layer 50.

Continuously referring to FIG. 3, the conductive layer 60 of the present invention is electrically connected to a circuit 70 with at least one conductive wire 80, wherein the circuit 70 can be a conventional touch switch circuit. When the robot arm 20 has the abnormal situation as shown in FIG. 2, a plurality of (at least one) charges are generated after the conductive layer 60 contacts the wafer 40b, and then these charges are transmitted to the circuit 70 via the conductive wire 80. After the circuit 70 receives the charges, a stop signal is generated to immediately stop the motion of the robot arm 20, thereby preventing the robot arm 20 from continuously scratching the subsequent wafer 40c. The circuit 70 also can generate a warning signal to drive an alarm device.

It is worthy to be noted that the structure of the present invention is quite simple, and can be briefly applied to a conventional robot arm, such as the robot arms of Mark 8 and ACT 8 manufactured by Tokyo Electronic Industry Company (TEL), Japan, thus converting a conventional robot arm into a robot arm of the present invention having wafer-scratching prevention function

To sum up, it is a major advantage of the present invention to provide a robot arm having wafer-scratching prevention function. The robot arm of the present invention can promptly detect the abnormal situation of a wafer scratched by a robot arm, thus stopping the motion of the robot arm promptly and limiting production loss to merely one single wafer without involving any other wafers, so that wafer scrap can be prevented and the wafer yield can be promoted.

It is the other advantage of the present invention to provide a robot arm having wafer-scratching prevention function. The feature of the present invention is that the present invention can be briefly installed on a conventional robot arm, thus having highly industrial value.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A robot arm having wafer-scratching prevention function, comprising:
a non-conductive layer, located on one surface of said robot arm, wherein said one surface is used for contacting a target wafer;
a conductive layer, located on the other surface of said robot arm, wherein said one surface and said other surface are located on both sides of said robot arm; and
a circuit, wherein said conductive layer is connected to said circuit with at least one conductive wire, so that when said conductive layer contacts a non-target wafer, at least one charge is generated and passed to said circuit.

2. The robot arm having wafer-scratching prevention function of claim 1, wherein said robot arm and said conductive layer are made of an electrically conductive material, and said non-conductive layer is made of an electrically non-conductive material.

3. The robot arm having wafer-scratching prevention function of claim 2, wherein said electrically non-conductive material is ceramic material.

4. The robot arm having wafer-scratching prevention function of claim 2, wherein said electrically conductive material is metal.

5. The robot arm having wafer-scratching prevention function of claim 1, wherein said robot arm and said non-conductive layer are made of an electrically non-conductive material, and said conductive layer is made of an electrically conductive material.

6. The robot arm having wafer-scratching prevention function of claim 5, wherein said electrically non-conductive material is ceramic material.

7. The robot arm having wafer-scratching prevention function of claim 5, wherein said electrically conductive material is metal.

8. The robot arm having wafer-scratching prevention function of claim 1, wherein said non-conductive layer covers said one surface entirely.

9. The robot arm having wafer-scratching prevention function of claim 1, wherein said conductive layer covers said other surface entirely.

10. The robot arm having wafer-scratching prevention function of claim 1, wherein said circuit is a touch switch circuit.

11. The robot arm having wafer-scratching prevention function of claim 1, wherein a stop signal is generated to stop the motion of said robot arm, after said circuit receives said at least one charge.

12. The robot arm having wafer-scratching prevention function of claim 1, wherein a warning signal is generated to drive an alarm device, after said circuit receives said at least one charge.

13. A robot arm having wafer-scratching prevention function, comprising:
a non-conductive layer, located on one surface of said robot arm, wherein said one surface is used for contacting a target wafer;
a conductive layer, located on the other surface of said robot arm, wherein said one surface and said other surface are located on both sides of said robot arm; and
a touch switch circuit, wherein said conductive layer is connected to said touch switch circuit with at least one conductive wire, so that when said conductive layer contacts a non-target wafer, at least one charge is generated and passed to said touch switch circuit, and a stop signal is generated to stop the motion of said robot arm, after said touch switch circuit receives said at least one charge.

14. The robot arm having wafer-scratching prevention function of claim 13, wherein said electrically non-conductive material is ceramic material.

15. The robot arm having wafer-scratching prevention function of claim 13, wherein said electrically conductive material is metal.

16. The robot arm having wafer-scratching prevention function of claim 13, wherein said non-conductive layer covers said one surface entirely.

17. The robot arm having wafer-scratching prevention function of claim 13, wherein said conductive layer covers said other surface entirely.

18. The robot arm having wafer-scratching prevention function of claim 13, wherein a warning signal is generated to drive an alarm device, after said circuit receives said at least one charge.

19. A robot arm having wafer-scratching prevention function, comprising:
a non-conductive layer, located on one surface of said robot arm, wherein said one surface is used for contacting a target wafer, and said robot arm is made of an electrically conductive material; and
a circuit, wherein said robot arm is connected to said circuit with at least one conductive wire, so that when the other surface of said robot arm contacts a non-target wafer, at least one charge is generated and passed to said circuit.

20. The robot arm having wafer-scratching prevention function of claim 19, wherein said electrically conductive material is metal.

21. The robot arm having wafer-scratching prevention function of claim 19, wherein said electrically non-conductive material is ceramic material.

22. The robot arm having wafer-scratching prevention function of claim 19, wherein said circuit is a touch switch circuit.

23. A robot arm having wafer-scratching prevention function, comprising:
a conductive layer, located on one surface of said robot arm, wherein said robot arm is made of an electrically non-conductive material; and
a circuit, wherein said conductive layer is connected to said circuit with at least one conductive wire, so that when said conductive layer contacts a non-target wafer, at least one charge is generated and passed to said circuit.

24. The robot arm having wafer-scratching prevention function of claim 23, wherein said electrically conductive material is metal.

25. The robot arm having wafer-scratching prevention function of claim 23, wherein said electrically non-conductive material is ceramic material.

26. The robot arm having wafer-scratching prevention function of claim 23, wherein said circuit is a touch switch circuit.
